(19) United States
(12) Patent Application Publication
(10) Pub. No.: US 2007/0257399 A1
(43) Pub. Date: Nov. 8, 2007

(54) Hose apparatus and method

(76) Inventors: Jeremy Jay Lidgett, Norfolk, NE (US); Andrew James Speidel, Norfolk, NE (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/499,945

(22) Filed: Aug. 7, 2006

Related U.S. Application Data
(60) Provisional application No. 60/725,040, filed on Oct. 7, 2005.

(51) Int. Cl. B29C 49/00

(52) U.S. Cl. 264/284; 138/121

(57) ABSTRACT

An apparatus and method for forming one or more grooves in a hose is disclosed. The groove forming device is comprised of a circular guide tube through which the hose is driven. The guide tube is rotated by a drive. The groove forming device is mounted at the exit end of the guide tube are rotated about the hose as the grooves are formed in the hose cover. The grooves of the hose are formed by at least one roller mounted on a chuck.

### TECHNICAL FIELD

The disclosed invention is directed toward a hose and hose manufacturing.

### BACKGROUND ART

Textured hoses are known in the art, with a variety of methods to accomplish such hoses. A pattern may be generated on the outer surface of the hose due to an underlying reinforcement layer, as disclosed in U.S. Pat. No. 4,957,792. Alternatively, by corrugated the hose material and applying a fabric layer as the outermost layer, as disclosed in U.S. Pat. No. 4,307,754 or U.S. Pat. No. 4,106,967. Additionally, U.S. Pat. No. 1,749,207 discloses applying a spiny projection material on tubular articles to create a textured article.

However, the texture on the hoses generally does not allow water or other chemicals to drain out from under the hose. Consequently, water or chemicals tend to pool, as the hose acts as a dam or barrier. Thus it is desired to have a hose that has an external configuration which allows the fluids to pass under the hose, so that the hose does not act as a dam.

### BRIEF DESCRIPTION OF DRAWINGS

The invention will be described by way of example and with reference to the accompanying drawings in which:

FIG. 1 is an overview of the hose cover application manufacturing process;

FIG. 2 is a front view of the hose cover groove apparatus;

FIG. 3 is a partial sectional side view of the hose cover groove apparatus;

FIG. 4 is a side view of the hose cover groove apparatus shown during the cutting operation;

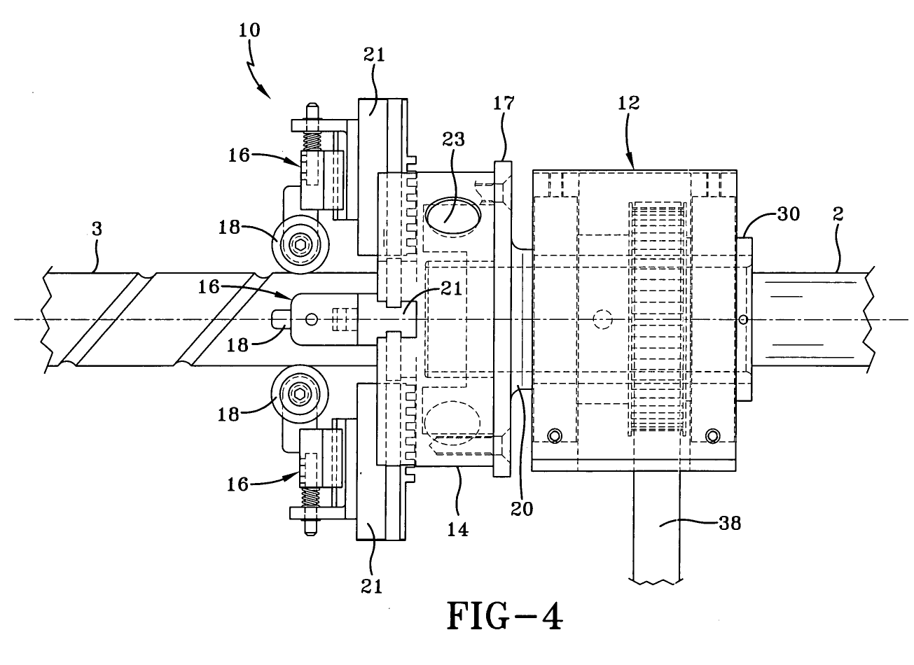

FIG. 5 illustrates one embodiment of the groove cutter mechanism;

FIGS. 6 and 7 illustrate a cross-sectional view and perspective view of one embodiment of a helical grooved hose;

FIGS. 8 and 9 illustrate a cross-sectional view and perspective view of a second embodiment of a helical grooved hose and

FIGS. 10 and 11 illustrate a cross-sectional view and perspective view of a third embodiment of a helical grooved hose.

### DETAILED DESCRIPTION OF THE INVENTION

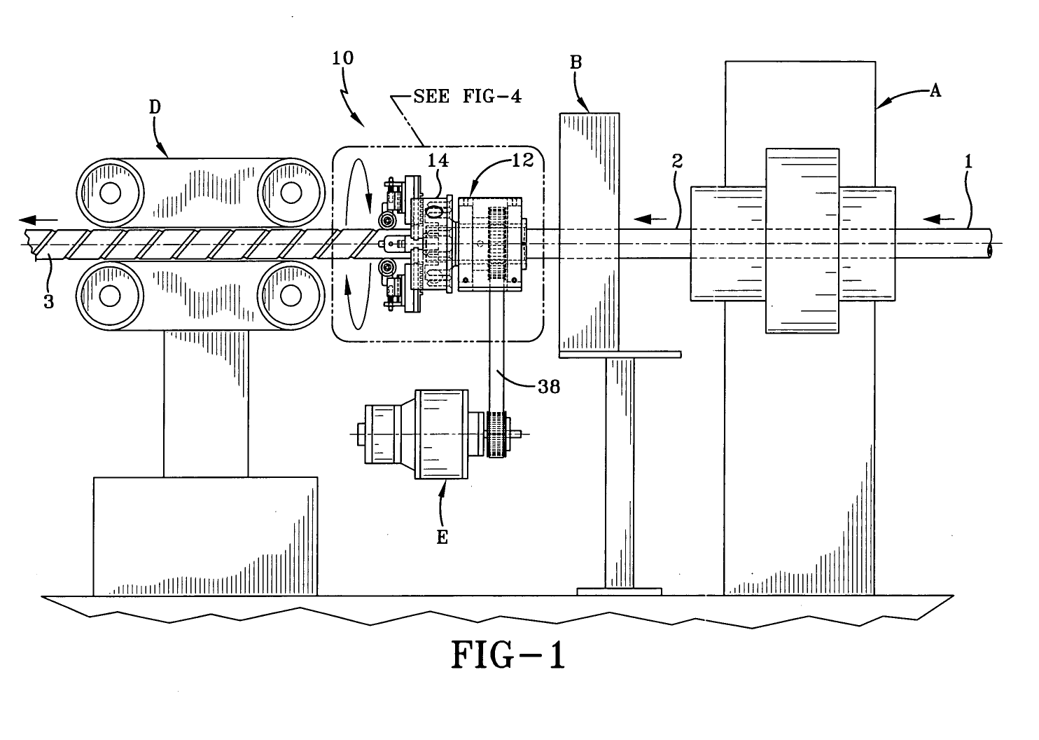

Illustrated in FIG. 1 is an overview of the hose cover grooving process. The uncovered hose 1, conventionally referred to as a hose carcass, is fed into a cover extruder A in the direction indicated by the arrow. The hose carcass 1 may be of any configuration depending upon the hose specification required. The cover extruder A applies an elastomeric or thermoplastic cover onto the hose carcass 1. After extrusion, the covered hose 2 may be fed through a target system B. The target system B determines the outside diameter (OD) of the hose 2, and automatically adjusts the thickness of the extruded cover to obtain the desired hose OD. If a target system B is not employed, a guide system may be positioned between the extruder A and the groove cutting device 10 to ensure that the centerline of the hose 2 is lined up with the centerline of the groove cutting device 10. The covered hose 2 is then fed into the groove cutting device 10. A conventional soft belt hose puller D for pulling the hose 1, 2, 3 through the cover application system may also be a part of the manufacturing process. The covered, grooved hose 3 is then fed into further processes such as labeling, cooling, or curing; the further processes, and the order in which they are accomplished, are dependent upon whether a rubber or plastic hose is being manufactured, and the usual order of manufacturing employed by the hose manufacturer.

The grooved cutting device 10 is divided into two portions, the right hand portion, relative to the hose direction illustrated, is the drive base 12, and the left hand portion is the chuck 14 with attached groove forming apparatus 16. The groove forming apparatus 16 includes a roller 18 mounted on a chuck jaw 21. The drive base 12 of the groove cutting device 10 is driven by a connected motor E, causing the guide tube 20 and chuck 14 to rotate as the hose 2 travels through the device 10. As the hose 2 is moving through the rotating grooved cutting device 10, the friction between the rollers 18 and the hose 2 act to rotate the rollers 18, each roller cutting a helical groove into the hose 2 with the desired angle and spacing. The drive base 12 is enclosed inside a bearing housing frame 22 for mounting the groove cutting device 10 within the manufacturing line.

The groove cutting device 10 may be sized to accommodate an unlimited diameter range. The maximum hose size is determined by the guide tube 20. The guide tube 20, extends the full width of the groove cutting device 10, connecting the drive base 12 and the chuck 14. The guide tube 20 has a constant internal diameter D_{I}. A constant internal diameter enables simpler manufacturing of the guide tube, however, the tube is not limited to a constant internal diameter D_{I}, but may vary the length of the tube 8. The external diameter D_{O} of the guide tube is selected base upon the bored internal diameters of the differing components of the texturing device, discussed below. If a variable external diameter D_{O} is selected, the transition may occur at the extending ring plate 10 as illustrated. Alternatively, the outside diameter D_{O} may be substantially identical on both sides of the ring plate 17. The extending ring plate 17 secures the chuck 14 to the guide tube 20.

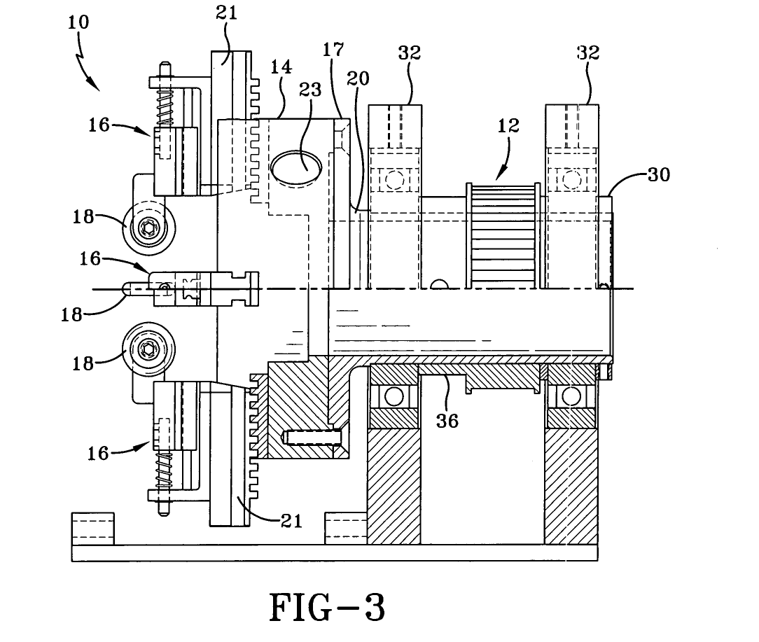

Illustrated in FIG. 3 is the groove cutting device 10. The drive base 12 employs an outer locking ring 30, two self-aligning bearings 32, and a gear belt pulley 36. The locking ring 30, bearings 32, and pulley 36 are aligned about the guide tube 20. A belting 38 (see FIG. 1) wraps about the gear belt pulley 36 and the motor E. As the belting 38 is driven by the motor E, the drive base 12 rotates the guide tube 20, rotating with it the chuck 14. The device C may be driven by other conventional systems such as chain drive system instead of the illustrated belting drive system.

Adjacent to the drive base 12 is the chuck 14. The chuck 14 is mounted on the extending ring plate 17 of the guide tube 20. The chuck 14 employs a gear (not shown) which operates to adjust and vary the locations of the chuck jaws 21, moving the chuck jaws 21, see FIG. 1 and further discussion below, radially inward and outward with respect to the centerline of the guide tube 20. Movement of the chuck jaws 21 is accomplished by the use of a chuck jaw wrench (not shown) inserted into a turning key 23. Turning keys 23 are located at opposing points on the outside of the chuck 14. Rotation of the turnkey 23 by means of the wrench rotates the internal gear to feed the chuck jaws 21 in and out by means of the gear. The chuck jaws 21 are inserted into the chuck jaw housings 34, with the first groove 36 resting adjacent the gear. As the gear is rotated, the chuck jaw 21 is threaded onto the chuck 14 by means of the chuck jaw teeth 38.

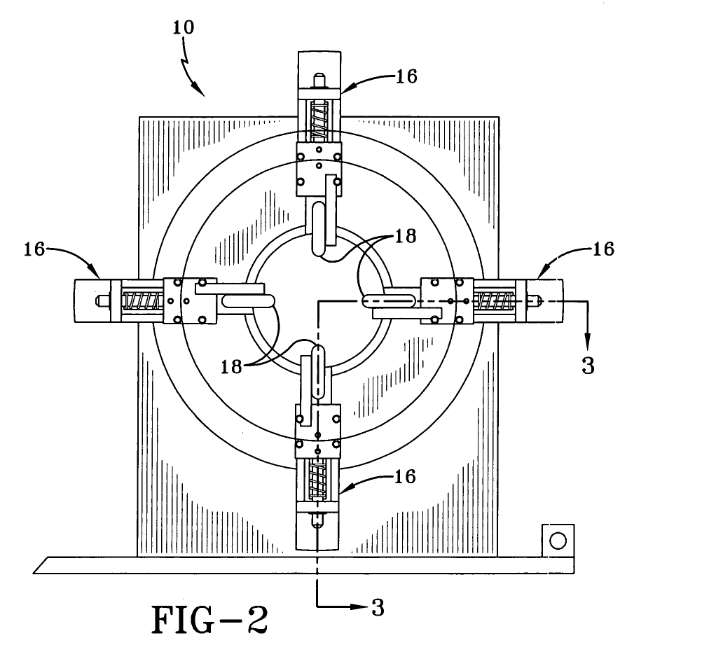

FIG. 2 illustrates the front view of the groove cutting device 10. Mounted on the chuck 14 is a set of chuck jaws 21 in the manner described above. For applying the desired grooves to the hose 2, a groove forming apparatus 16 is mounted onto each chuck jaw 21. Each groove forming apparatus 16 has a roller 18. The roller 18 may be optionally spring loaded via compression spring 43. The chuck jaws 21 are mounted at equal intervals about the chuck 14. The axis of rotation of the roller 18 is about perpendicular to the longitudinal axis of the guide tube 20 and the hose 2 traveling through the groove cutting device 10. As described above, the chuck jaws 21 are moved in and out, relative to the centerline of the guide tube 20, by means of the internal gear. Varying the distance of the chuck jaws 21 permit the device to accommodate a range of hose diameters.

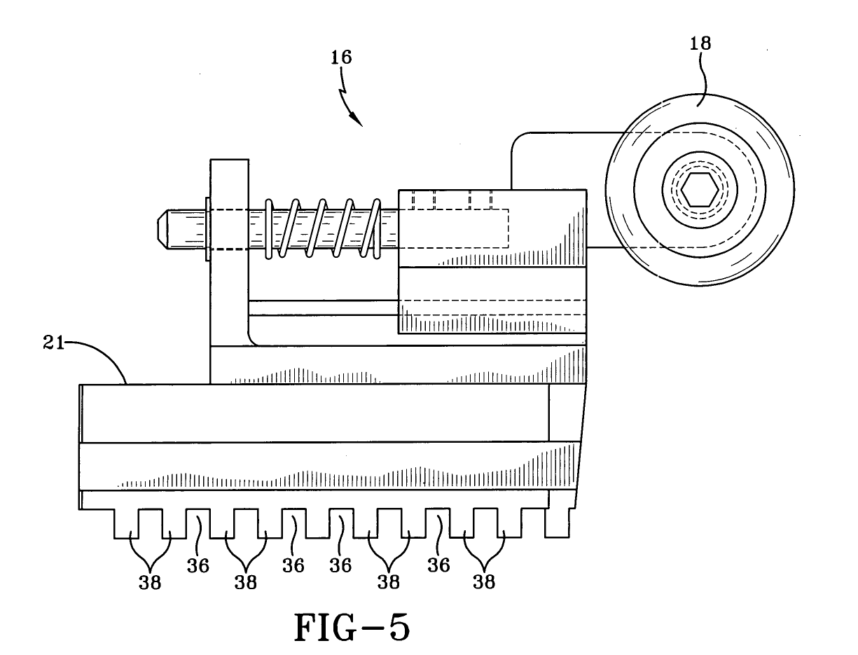

FIG. 5 illustrates one embodiment of the rollers 18. The roller 18 is mounted at one end of the chuck jaw 21. The underside of the chuck jaw 21 is provided with a series of teeth 38 for mounting the chuck jaw 21 onto the chuck 14. The roller 18 is rotatably mounted on the chuck jaw permitting the roller 18 to freely rotate on the chuck jaw 21 as the chuck 14 rotates about the hose 2 being fed through the groove cutting device 10. When in operation, the hose 2 is subject to a double rotation, the first rotation of the guide tube 20 and attached chuck 14, and the rotation of each individual roller 18, creating a complete helical groove 40 on the hose 2. The angle of the helix may vary depending upon the speed of the machine. The faster the machine, the deeper the depth of the groove and the higher the angle. The angle of the helix may vary, but it is preferably in the range of about 20 to about 45 degrees. The depth of the groove may vary, but it is preferably in the range of about 0.015 to about 0.05 inches.

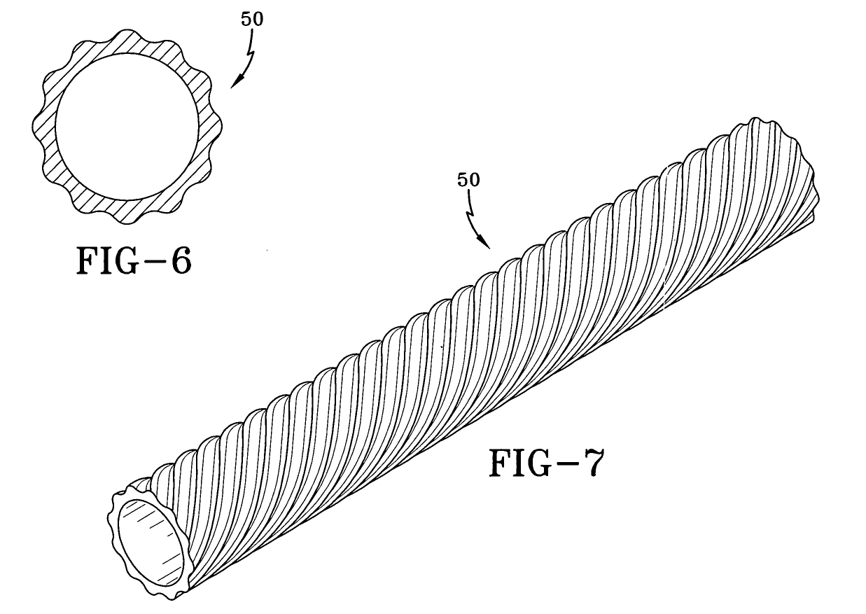

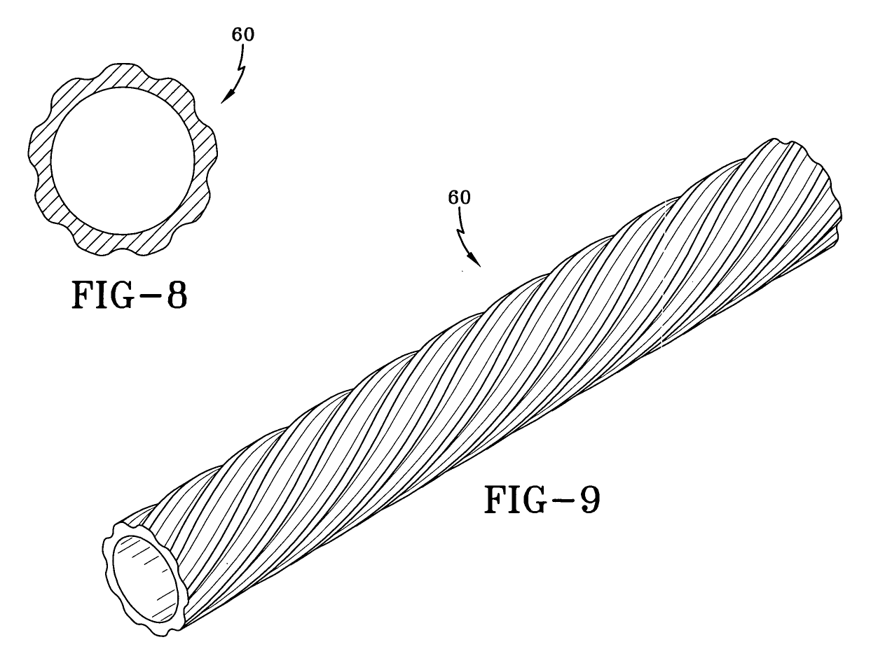

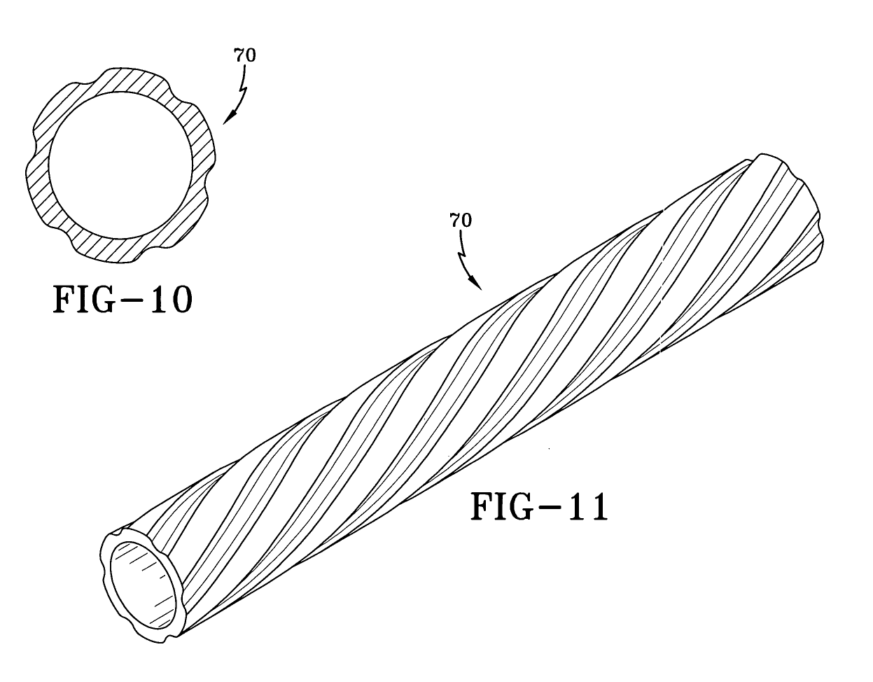

FIGS. 6-11 illustrate three embodiments of the resulting grooved hose 50, 60 and 70. The hose 3 is a multi-layered laminate with an outermost cover layer that has grooves formed therein. The angle of the groove helix, the depth of the grooves varies depending on the speed of the machine.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention.

1. An apparatus for forming a groove in a hose, the apparatus comprising a drive member, and a groove forming device,
the drive member being associated with the guide to cause rotation of the guide and;
the groove forming device rotating with the guide to form a groove in the hose.

2. The apparatus of claim 1 wherein the groove forming device further comprises either a roller.

3. A hose having an inner rubber layer, a middle reinforcing layer and an outer cover, the outer cover further comprising one or more helical grooves having a depth in the range of about 0.015 to 0.05 inches.

4. The hose of claim 3 wherein the angle of the grooves is in the range of about 20 to about 45 degrees.
